(19) United States
(12) Patent Application Publication
(10) Pub. No.: US 2004/0267973 A1
(43) Pub. Date: Dec. 30, 2004

(54) Device and host machine

(75) Inventors: Masahiko Sumida, Kawasaki (JP); Yoshihiro Takamatsuya, Kawasaki (JP); Kazuyuki Takaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/871,367

(22) Filed: Jun. 21, 2004

Related U.S. Application Data
(63) Continuation of application No. PCT/JP02/00598, filed on Jan. 28, 2002.

(51) Int. Cl. G06F 13/10; G06F 9/24; G06F 15/177

(52) U.S. Cl. 710/8; 713/1

(57) ABSTRACT

The present invention aims to provide a device having a common essential component, for example, a common LSI, and a host machine having a common device driver. A USB device 10 has a plug-and-play capability that allows the device 10, upon being connected to a PC 15, to pass to the PC 15 device ID 11a or 11b for selecting a device driver 16 that controls the device 10 and operates under the control of the device driver 16 provided in the PC 15. The device has an LSI 12 retaining two selectable device IDs 11a and 11b.

### TECHNICAL FIELD

The present invention relates to a host machine, such as a computer, and a device serving as peripheral equipment for the host machine.

### BACKGROUND ART

With the proliferation of personal computers (PC) in recent years, devices used as peripheral equipment therefor have been increasingly developed and marketed. Among others, many manufacturers are now developing various types of plug-and-play devices because of their high operability; such a device can be made ready for use simply by plugging the connector of the device into the port on the host PC.

Of the plug-and-play devices, universal serial bus (USB) devices have achieved particularly remarkable proliferation and become widely used as input/output devices, storage devices, communication devices or the like. For example, recent cellular phones incorporate USB interfaces.

Such a USB device has unique identification information for identifying the device, which is referred to as a device ID. When the USB device is connected to a PC, the operating system (OS) in the PC reads the device ID, retrieves the information file corresponding to the device ID and installs and loads the device driver (driver software that manages and controls peripheral equipment) specified by the information file, thereby making the USB device operate as peripheral equipment for the PC.

Generally, one device driver is related to one USB device. If plural types of USB devices are used, device drivers are prepared for the respective types of USB devices, and the PC has to install device drivers designed for the respective USB devices used.

FIG. 12 is a diagram for illustrating operations of a conventional USB device and a PC connected to each other.

As shown in FIG. 12, a USB device 100 and a PC 200 operate as follows.

1. A USB connector of the USB device 100 is plugged into a USB port of the PC 200.

2. An OS 201 of the PC 200 reads a device ID 101 retained in the USB device 100.

3. The OS 201 retrieves an information file 202 corresponding to the device ID 101.

4. The OS 201 refers to a file name 202a described in the information file 202 and installs and loads a device driver 203.

5. The USB device 100 operates as peripheral equipment for the PC 200 under the control of the device driver 203.

In the information file 202 in the PC 200, a product name 202b of the USB device 100 is described along with the file name 202a of the device driver corresponding to the device ID 101. When the USB device 100 is plugged into the PC 200, the product name 202b is displayed on a display unit 204 of the PC 200.

In the case where such USB devices are sold to plural client companies on an OEM (original equipment manufacturing) basis, some OEM client companies may request the OEM supplier to adapt the product name or other information about the USB device, which is to be displayed on the PC, for the clients. In such a case, in order for the product names or other information adapted for different OEM clients to be displayed in spite of the fact that the USB devices as peripheral equipment operate essentially in the same manner, different device drivers have to be prepared for the OEM clients.

In general, if plural USB devices which are available as OEM products and have same hardware and a same device ID are used on one PC, competition may occur among the device drivers, making proper display or other operation impossible.

In order to avoid such a problem, a different device ID may be prepared for each OEM client company. Conventionally, a large scale integrated circuit (LSI) dedicated for each client company which retains the device ID for the OEM client company is manufactured, or a common LSI is used and the device ID for each OEM client company is written to a non-volatile memory.

FIG. 13 is a schematic diagram showing correspondences between USB devices and PCs in the case where a dedicated LSI is used for each OEM client company.

A USB device 100a for an A company and a USB device 100b for a B company have essentially the same hardware and are designed to operate as peripheral equipment in the same manner when connected to the irrespective PCs 200. Therefore, the device drivers provided in the PCs 200 to which the USB devices are connected should adequately provide the same control operation. However, in many cases, the client A company requests to display the product name given by the A company on the display unit when the USB device 100a for the A company is connected to the PC 200, and, similarly, the client B company requests to display the product name given by the B company on the display unit when the USB device 100b for the B company is connected to the PC 200.

Thus, as shown in FIG. 13, before supplying the USB devices to the respective clients, the OEM manufacturer embeds a device ID 101a retaining the product name given by the A company in the USB device 100a for the A company and embeds a device ID 101b retaining the product name given by the B company in the USB device 100b for the B company.

According to this method, in order to use the USB device 100a for the A company on the PC 200, a device driver 203a for the A company has to be set up in the PC 200. Similarly, in order to use the USB device 100b for the B company on the PC 200, a device driver 203b for the B company has to be set up in the PC 200.

As described above, the OEM manufacturer has to prepare USB devices incorporating dedicated LSI for different OEM client companies, and the PC users have to prepare a device driver designed for the device to be used.

FIG. 14 is a schematic diagram showing a correspondence between an USB device and a PC in the case where plural device IDs are written to a non-volatile memory in the USB device.

In this case, as shown in FIG. 14, a USB device 100 uses common hardware having a common LSI regardless of whether it is for the A company or B company, and a device ID for the A company and a device ID for the B company are both written to a non-volatile memory 101. Before shipping, the non-volatile memory 101 is rewritten so that one, for the A or B company, of the device IDs remains in the non-volatile memory, the remaining one being referred to as a device ID 101c. On the other hand, the PC 200 incorporates a device driver 203c designed for both the A and B companies.

However, according to this method, the rewriting of the non-volatile memory has to be conducted before shipping, and the special device driver 203c available for plural device IDs has to be provided in the PC.

Furthermore, on the PC side, the user has to change the device name each time the USB device used is changed, which is an annoying operation.

### DISCLOSURE OF THE INVENTION

In view of such circumstances, an object of the present invention is to provide a device having a common essential component, for example, a common LSI, and a host machine having a common device driver.

In order to attain the object described above, a first device according to the present invention is a device that has a plug-and-play capability that allows the device to pass a device ID for selecting a device driver that controls the device to a host machine when connected to the host machine and operates under the control of the device driver in the host machine to which the device is connected, having:

an ID retaining section that retains plural device IDs in a selectable manner.

With the first device according to the present invention, there is no need to prepare a dedicated component for each OEM client, such as an LSI or non-volatile memory retaining a dedicated device ID for each OEM client. For example, since only needed is to customize the device ID by modifying wiring or a switch of the finished product, the device can have a common essential component.

The “device” according to the present invention refers to various auxiliary devices which are connected to a host machine and serve as peripheral equipment therefor, including various input/output devices, storage devices, communication devices or the like. The “host machine” according to the present invention refers to various types of computers that use the devices described above as peripheral equipment.

The first device according to the present invention may further have an ID selecting section that fixedly selects, from among the plurality of device IDs retained in the ID retaining section, a device ID to be passed to the host machine when the device is connected to the host machine.

If the first device is thus configured, the device can have a common essential component, requiring only a simple operation, such as modification of the setting of a general I/O port.

In order to attain the object described above, a second device according to the present invention is a device that has a plug-and-play capability that allows the device to pass a device ID for selecting a device driver that controls the device to a host machine when connected to the host machine and operates under the control of the device driver in the host machine to which the device is connected, having:

an ID retaining section that retains the device ID and retains, in a selectable manner, plural function IDs to be passed to the host machine when the device is connected to the host machine.

The second device according to the present invention can have a common essential component and operate in plural modes without needing dedicated components for different OEM clients, such as LSIs or memories retaining dedicated device IDs for different OEM clients.

The second device may further have an ID selecting section that fixedly selects, from among the plurality of function IDs retained in the ID retaining section, a function ID to be passed to the host machine along with the device ID when the device is connected to the host machine.

If the second device is thus configured, the device can have a common essential component capable of operating in plural operation modes, requiring only a simple operation.

In order to attain the object described above, a first host machine according to the present invention is a host machine that has a plug-and-play capability that allows the host machine to receive a device ID for selecting a device driver that controls a device and select the device driver when a device is connected thereto and controls the connected device using the device driver corresponding to the device ID received from the device, having:

plural information files that describe file names of the device driver and are associated with device IDs; and

a device driver setting section that selects, based on a device ID for selecting a device driver received from the device connected thereto, an information file corresponding to the device ID from among the plurality of information files and sets a device driver corresponding to the file name described in the selected information file as the device driver for the device connected thereto,

in which the plurality of information files are associated with different device IDs and include plural information files describing the same file name.

With the first host machine according to the present invention, since a device driver common to OEM clients is automatically selected based on the information retained in the hardware of the device, there is no need to prepare dedicated device drivers for different OEM clients, and the host machine can have a common device driver.

The information files may each describe a file name of the device driver and a device name,

the plurality of information files provided in the host machine may be associated with different device IDs and include plural information files describing the same file name and different names, and

the host machine may further have a display section that displays the name described in the information file selected based on the device ID.

If the first host machine is thus configured, a display adapted for each OEM client can be provided by a simple method.

Furthermore, in order to attain the object described above, a second host machine according to the present invention is a host machine that has a plug-and-play capability that allows the host machine to receive a device ID for selecting a device driver that controls a device and select the device driver when a device is connected thereto and controls the connected device using the device driver corresponding to the device ID received from the device, having:

an ID acquisition section that receives the device ID for selecting a device driver from the connected device and receives a function ID for selecting an operation mode of the device driver selected based on the device ID; and

the device driver which is selected based on the device ID acquired by the ID acquisition section and whose operation mode is selected based on the function ID acquired by the ID acquisition section.

With the second host machine according to the present invention, since a device driver common to OEM clients is automatically selected and the operation mode of the device driver is automatically switched from one to another based on the information retained in the hardware of the device, there is no need to prepare dedicated device drivers for different OEM clients, and the host machine can have a common device driver.

Furthermore, in order to attain the object described above, a third host machine according to the present invention is a host machine that has a plug-and-play capability that allows the host machine to receive a device ID for selecting a device driver that controls a device and select the device driver when a device is connected thereto and controls the connected device using the device driver corresponding to the device ID received from the device, having:

an ID acquisition section that receives the device ID for selecting a device driver from the connected device and receives a function ID for selecting an operation mode of the device driver selected based on the device ID; and

the device driver which is selected based on the device ID acquired by the ID acquisition section and passes the function ID acquired by the ID acquisition section to an application program that uses the connected device under the control of the device driver.

With the third host machine according to the present invention, since a device driver common to OEM clients is automatically selected and the operation mode of the application is automatically switched from one to another based on the information retained in the hardware of the device, the burden on the user is reduced.

As described above, the device according to the present invention does not require dedicated components for different OEM clients, such as LSIs or memories retaining dedicated device IDs for different OEM clients, and can have a common essential component. Thus, the device can be produced at a lower cost.

In addition, the host machine according to the present invention can have a common device driver, and thus, the host machine can be produced at a lower cost and managed more easily.

Furthermore, with the device and host machine according to the present invention, the device driver in the host machine is automatically selected or the operation mode of the device is automatically switched from one to another based on the information retained in the hardware of the device. Thus, the burden on the user can be reduced, and the commercial value of the device and/or host machine can be significantly raised.

### BRIEF DESCRIPTION OF THE DRAWINGS

FIG. 1 externally shows a plug-and-play device and a host machine;

FIG. 2 is a schematic diagram showing a first embodiment of a device according to the present invention;

FIG. 3 shows, in detail, an LSI and general I/O ports of the device of the first embodiment shown in FIG. 2;

FIG. 4 is a schematic diagram showing a second embodiment of the device according to the present invention;

FIG. 5 shows, in detail, an LSI and general I/O ports of the device of the second embodiment shown in FIG. 4;

FIG. 6 is a schematic diagram showing a first embodiment of a host machine according to the present invention;

FIG. 7 is a schematic diagram showing a second embodiment of the host machine according to the present invention;

FIG. 8 is a schematic diagram showing a third embodiment of the host machine according to the present invention;

FIG. 9 is a schematic diagram showing a fourth embodiment of the host machine according to the present invention;

FIG. 10is a schematic diagram showing a fifth embodiment of the host machine according to the present invention;

FIG. 11 is a flowchart illustrating an operation of the host machine of the fifth embodiment;

FIG. 12 is a diagram for illustrating operations of a conventional USB device and a PC connected to each other;

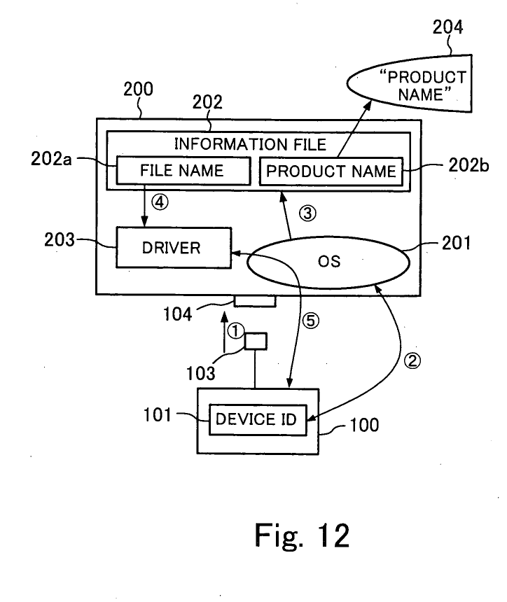

FIG. 13 is a schematic diagram showing correspondences between USB devices and PCs in the case where a dedicated LSI is used for each OEM client company; and

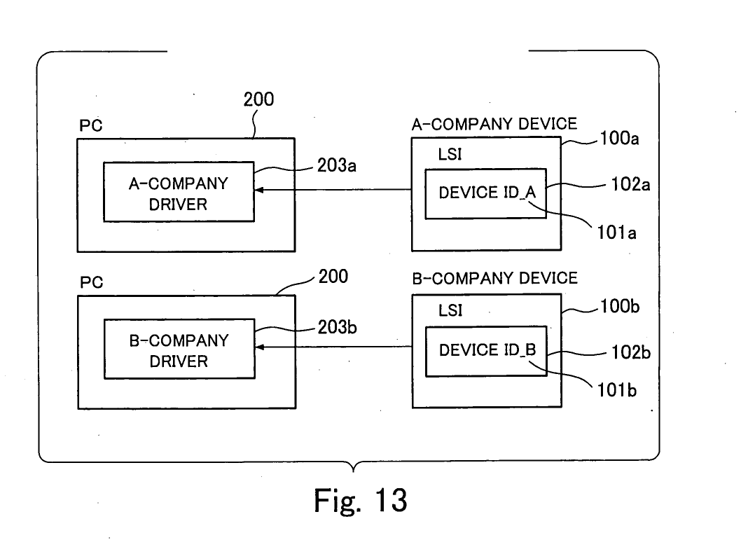

FIG. 14 is a schematic diagram showing a correspondence between an USB device and a PC in the case where plural device IDs are written to a non-volatile memory in the USB device.

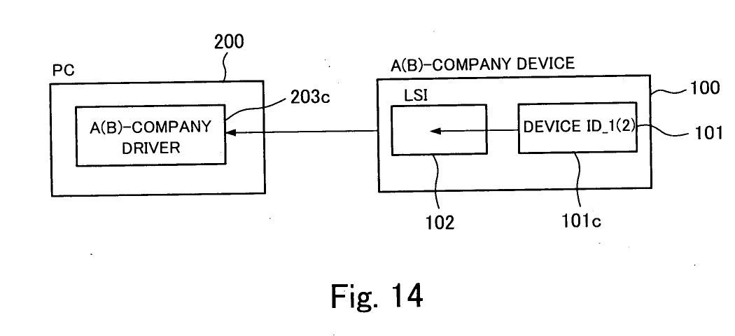

### BEST MODE FOR CARRYING OUT THE INVENTION

In the following, embodiments of the present invention will be described.

The following description of the embodiments will be made concerning a case where a universal serial bus (USB) device, which is a “device” according to the present invention, is connected to a personal computer (PC), which is a “host machine” according to the present invention, to make the USB device serve as peripheral equipment for the PC.

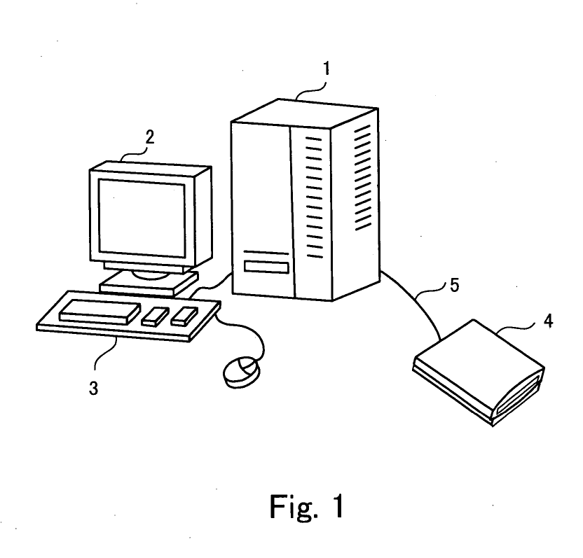

FIG. 1 externally shows a plug-and-play device and a host machine.

FIG. 1 shows a desktop PC main unit 1, a display unit 2 and a keyboard 3 both connected to the PC main unit 1, and an external storage unit 4. The storage unit 4, which is a “device” according to the present invention, is a plug-and-play USB device that is connected to the PC main unit 1 via a USB cable 5 and passes the device ID to the PC main unit 1.

The PC system including the PC main unit 1, the display unit 2 and the keyboard corresponds to a plug-and-play “host machine” according to the present invention.

The USB cable 5 has two differently configured USB connectors of types A and B (not shown) each provided at either end. Simply connecting the type-B connector of the USB cable 5 to the storage unit 4 and plugging the type-A connector of the USB cable 5 into a USB port (not shown) on the PC main unit 1 can make the storage unit 4 operate as peripheral equipment for the PC main unit 1.

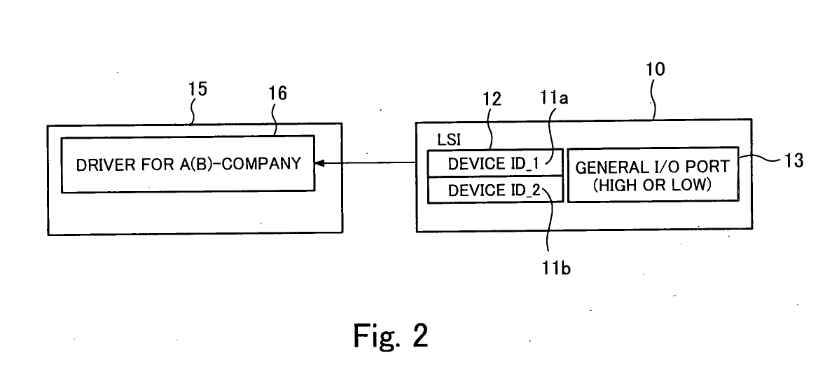

FIG. 2 is a schematic diagram showing a first embodiment of the device according to the present invention.

A device 10 of this embodiment corresponds to a first device according to the present invention.

As shown in FIG. 2, the device 10 is a USB device that has a plug-and-play capability that allows the device, upon being connected to a PC 15, to pass thereto device ID 11a or 11b for selecting a device driver 16 that controls the device 10 and operates under the control of the device driver 16 provided in the PC 15. The device 10 has an LSI 12 retaining two selectable device IDs 11a and 11b. The LSI 12 has a general I/O port 13.

The general I/O port 13 can be switched between two states, High and Low. For example, when the general I/O port 13 is set to the High state, the device 10 passes the device ID 11a to the PC 15 when it is connected to the PC 15, and when the general I/O port 13 is set to the Low state, the device 10 passes the device ID 11b to the PC 15 when connected to the PC 15.

The device driver 16 in the PC 15, which is designed for both A and B companies, controls the PC 15 in such a manner that the PC 15 performs operations for the A company, such as displaying names of products available from the A company, when receiving the device ID 11a from the device 10 and performs operations for the B company when receiving the device ID 11b from the device 10.

In this way, by providing the general I/O port 13 with an ID selection capability which allows fixed selection of one, which is to be passed to the PC 15 when the device 10 is connected to the PC 15, of the two device IDs 11a and 11b retained in the LSI 12, a common USB device that can readily select a device ID is provided.

The PC 15 in this embodiment corresponds to the host machine according to the present invention, the LSI 12 in this embodiment corresponds to an ID retaining section according to the present invention, and the general I/O port 13 in this embodiment corresponds to an ID selecting section according to the present invention.

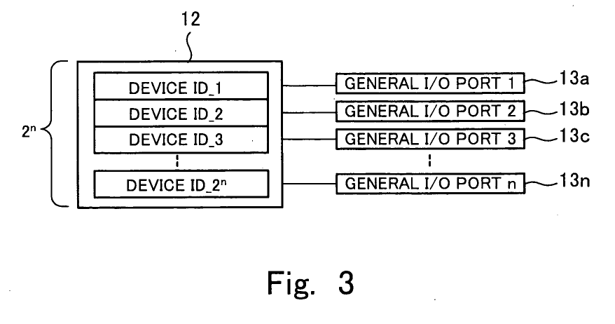

FIG. 3 shows, in detail, the LSI and general I/O ports of the device of the first embodiment shown in FIG. 2.

As shown in FIG. 3, the LSI 12 has n general I/O ports 13a, 13b, . . . , 13n, each of which can be switched between two states, High and Low. Thus, the LSI 12 can retain 2n device IDs, so that the PC 15 (see FIG. 2) can operate in 2ⁿ manners.

Now, a second embodiment of the device according to the present invention will be described.

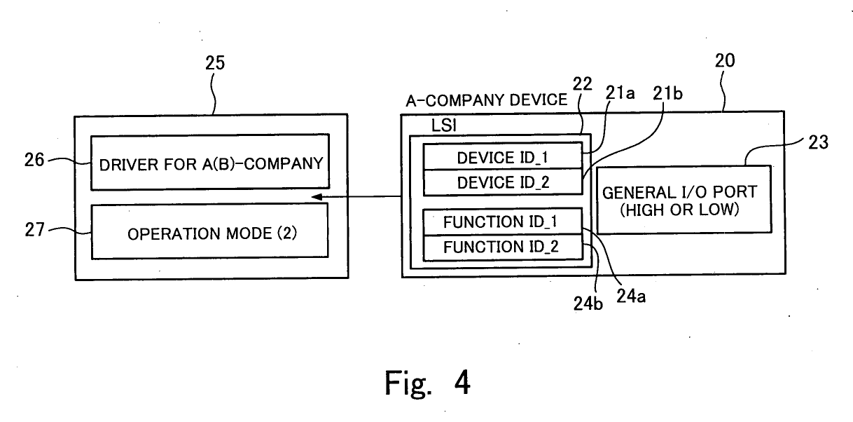

FIG. 4 is a schematic diagram showing the second embodiment of the device according to the present invention.

A device 20 of this embodiment corresponds to a second device according to the present invention.

As shown in FIG. 4, the device 20 of this embodiment is a USB device that has a plug-and-play capability that allows the device, upon being connected to a PC 25, to pass thereto function ID 24a or 24b to be used by an operation mode selecting section 27 for selecting an operation and operates as directed by the operation selecting section 27 provided in the PC 25.

An LSI 22 of the device 20 has an LSI 12 that retains device IDs 21a and 21b similar to those in the device of the first embodiment and the selectable function IDs 24a and 24b, each of which represents an operation mode. The LSI 22 has a general I/O port 23.

The general I/O port 23 can be switched between two states, High and Low. For example, when the general I/O port 23 is set to the High state, the device 20 passes the device ID 21a for the A company and the function ID 24a for the A company to the PC 25 when it is connected to the PC 25, and when the general I/O port 23 is set to the Low state, the device 20 passes the device ID 21b for the B company and the function ID 24b for the B company to the PC 25 when connected to the PC 25.

A device driver 26 in the PC 25, which is designed for both the A and B companies, operates the same regardless of whether the device ID received from the device 20 is for the A company or the B company. However, in the PC 25, when the function ID 24a for the A company is received from the device 20, the operation mode selecting section 27 set an operation mode for the A company, and when the function ID 24b for the B company is received from the device 20, an operation mode for the B company is set.

In this way, by providing the general I/O port 23 with an ID selection capability which allows fixed selection of one, which is to be passed to the PC 25 when the device 20 is connected to the PC 25, of the two function IDs 24a and 24b retained in the LSI 22, a common USB device that can readily select a function ID is provided.

In this embodiment, since the device has the function IDs as well as the device IDs, the host machine can provide operations different from those according to the device IDs.

The PC 25 in this embodiment corresponds to the host machine according to the present invention, the LSI 22 in the host machine in this embodiment corresponds to the ID retaining section according to the present invention, and the general I/O port 23 in the host machine in this embodiment corresponds to the ID selecting section according to the present invention.

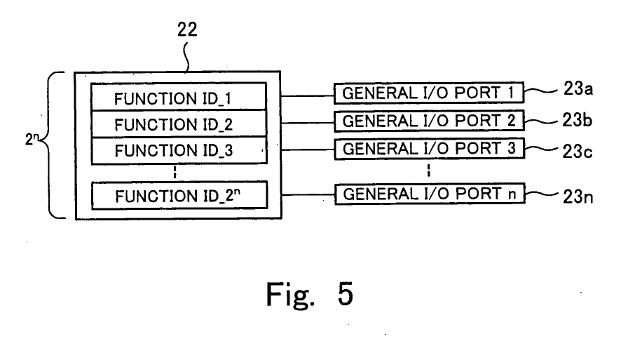

FIG. 5 shows, in detail, the LSI and general I/O ports of the device of the second embodiment shown in FIG. 4.

As shown in FIG. 5, the LSI 12 has n general I/O ports 23a, 23b, . . . , 23n, each of which can be switched between two states, High and Low. Thus, the LSI 22 can retain 2ⁿ function IDs, so that the PC 25 (see FIG. 4) can operate in 2ⁿ manners.

Now, an embodiment of the host machine according to the present invention will be described.

A host machine 35 of this embodiment corresponds to a first host machine according to the present invention.

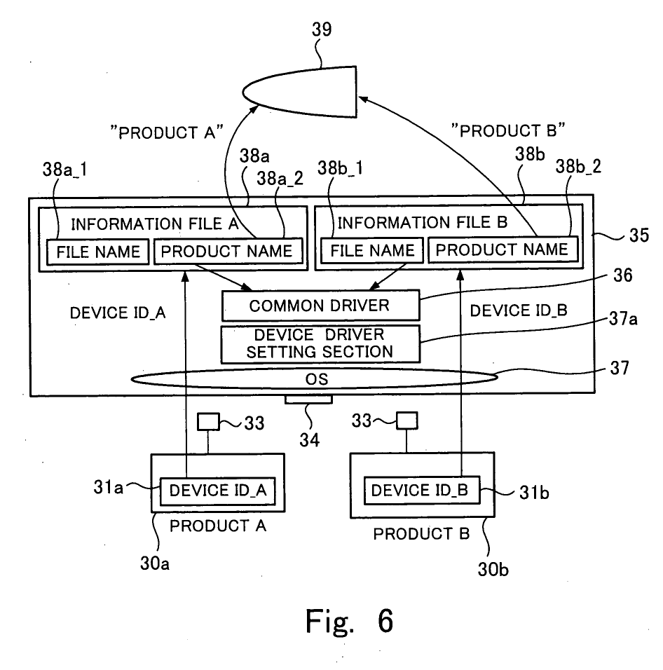

FIG. 6 is a schematic diagram showing a first embodiment of the host machine according to the present invention.

The host machine of this embodiment uses a common device driver for plural devices, such as an A-company device and a B-company device. As with the devices of the first and second embodiments (see FIGS. 2 to 5), the devices connected to the host machine have essentially the same hardware and are produced on an OEM basis for plural clients, such as the A company and B company. The product name, initial value or the like of each device is changed for the OEM client by external setting thereof including the setting of the general I/O port.

As shown in FIG. 6, the PC 35 has a plug-and-play capability that allows the PC 35 to receive a device ID 31a or 31b for selecting a device driver 36 from a device 30a or 30b and select the device driver 36 when a USB connector 33 of the device 30a or 30b is plugged into a USB port 34.

The PC 35 has two information files 38a and 38b which describe file names of the device driver 36 and are associated with the device IDs 31a and 31b, respectively. Furthermore, the PC 35 has a device driver setting section 37a that selects, based on the device ID 31a or 31b received from the connected device ID, one of the two information files 38a and 38b which corresponds to the received device ID and sets a device driver specified by a file name 38a_1 or 38b_1 described in the selected information file as the device driver 36 for the connected device.

The information files 38a and 38b are associated with different device IDs and have the respective device driver file names 38a_1 and 38b_1 and product names 38a_2 and 38b_2 described therein corresponding to the respective device IDs. The two file names 38a_1 and 38b_1 are file names of the same device driver.

With such a configuration, one common device driver 36 is always used in the PC 35 even if different device IDs are received from the devices connected thereto. However, since the device IDs received from the devices are associated with their respective devices, operations corresponding to the respective devices can be provided, for example, a display section 39 displays the product name of the connected device, that is, “product A” or “product B”.

Therefore, a common device having a common hardware component can be produced on an OEM basis, and a common device driver can be supplied to each OEM client. Thus, plural devices, such as an A-company device and a B-company device, can operate on one PC.

The PC 35 in this embodiment corresponds to the host machine according to the present invention.

Now, a second embodiment of the host machine according to the present invention will be described.

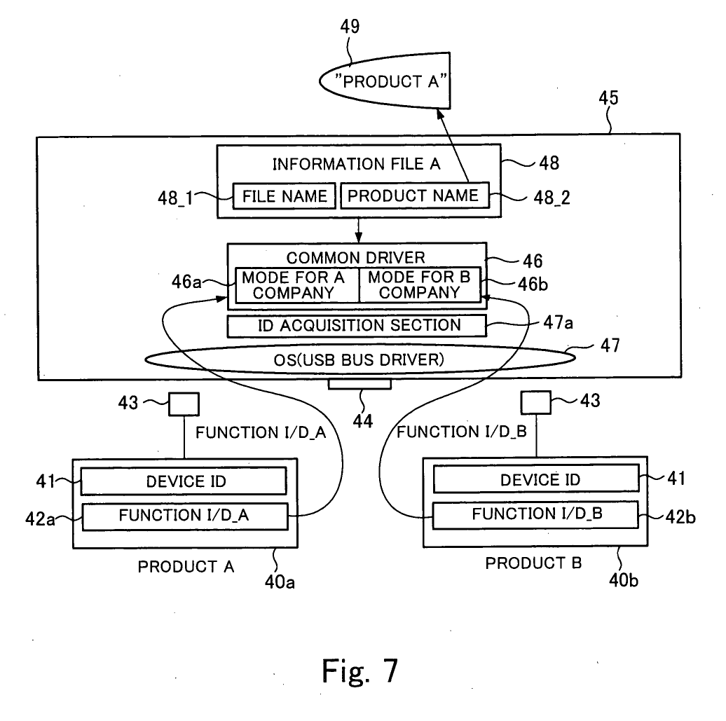

FIG. 7 is a schematic diagram showing the second embodiment of the host machine according to the present invention.

A host machine 45 in this embodiment corresponds to a second host machine according to the present invention.

The host machine of this embodiment uses a common device driver for plural devices, such as an A-company device and a B-company device. As with the devices of the first and second embodiments (see FIGS. 2 to 5), the devices connected to the host machine have essentially the same hardware and are produced on an OEM basis for plural clients, such as the A company and B company. The product name, initial value or the like of each device is changed for the OEM client by external setting thereof including the setting of the general I/O port.

As shown in FIG. 7, the PC 45 has a plug-and-play capability that allows the PC 45 to receive a device ID 41 for selecting a device driver 46 from a device 40a or 40b and select the device driver 46 when a USB connector 43 of the device 40a or 40b is plugged into a USB port 44.

The PC 45 has an information file 48 which describes a file name 48_{—}1 of the device driver 46 and a product name 48_{—}2, which are associated with the device ID 41. Furthermore, the PC 45 has: an ID acquisition section 47a that receives, from the connected device, the device ID 41 for selecting the device driver 46 and a function ID 42a or 42b for selecting an operation mode of the device driver specified by the device ID; and the device driver 46 which is selected based on the device ID acquired by the ID acquisition section 47a and whose operation mode is selected based on the function ID 42a or 42b acquired by the ID acquisition section 47a.

The device driver 46 has two selectable operation modes 46a and 46b, one of which is selected depending on the function ID acquired by the ID acquisition section 47a, that is, depending on whether the function ID 42a or 42b.

In the host machine of the second embodiment, the same device ID 41 is assigned to the devices 40a and 40b, and therefore, the same device driver 46 is always selected. However, since the function IDs 42a and 42b describe different operation modes, the device driver 46 provides an operation corresponding to selected one of the operation modes.

Since only one product name 48_{—}2 is described in the information file 48, “product A”, for example, can be constantly displayed on a display unit 49 regardless of the device connected to the PC.

With such a configuration, a common device having a common essential component can be produced on an OEM basis, a common device driver can be supplied to each OEM client, and plural devices, such as an A-company device and a B-company device, can operate on one PC.

The PC 45 in this embodiment corresponds to the host machine according to the present invention.

Now, the host machine according to the present invention will be further described.

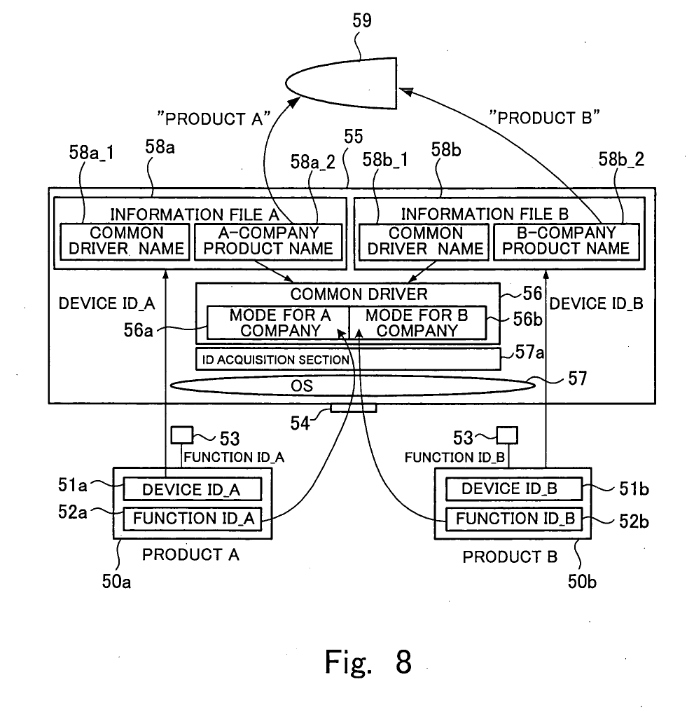

FIG. 8 is a schematic diagram showing the third embodiment of the host machine according to the present invention.

A host machine 55 in this embodiment corresponds to the second host machine according to the present invention and is a modification of the host machine 45 of the second embodiment.

As with the host machine of the second embodiment (see FIG. 7), the host machine of this embodiment uses a common device driver for plural devices, such as an A-company device and a B-company device. In addition, as with the devices of the first and second embodiments (see FIGS. 2 to 5), the devices connected to the host machine have essentially the same hardware and are produced on an OEM basis for plural clients, such as the A company and B company. The product name, initial value or the like of each device is changed for the OEM client by external setting thereof including the setting of the general I/O port.

As shown in FIG. 8, the PC 55 has a plug-and-play capability that allows the PC 55 to receive a device ID 51a or 51b for selecting a device driver 56 from a device 50a or 50b and select the device driver 56 when a USB connector 53 of the device 50a or 50b is plugged into a USB port 54.

Furthermore, the PC 55 has two information files 58a and 58b which describe file names 58a_1 and 58b_1 of the device driver 56 and product names 58a_2 and 58b_2, respectively, which are associated with the two device IDs 51a and 51b, respectively. Furthermore, the PC 55 has an ID acquisition section 57a that receives, from the connected device, the device ID 51a or 51b for selecting the device driver 56 and a function ID 52a or 52b for selecting an operation mode of the device driver specified by the received device ID.

The device driver 56 is selected based on the device ID 52a or 52b acquired by the ID acquisition section 57a.

The device driver 56 has two selectable operation modes 56a and 56b, one of which is selected depending on the function ID acquired by the ID acquisition section 57a, that is, depending on whether the function ID 52a or 52b.

The PC 55 in this embodiment corresponds to the host machine according to the present invention.

In the third embodiment, the file names 58a_1 and 58b_1 described in the information files 58a and 58b associated with the device IDs 51a and 51b, respectively, are those of the device driver 56, which is a device driver common to the products A and B, and the following operations are provided.

### EXAMPLE 1

In the case where the PC uses the Windows 2000 as the OS, if the device 50b, which is a B-company product, is connected to the PC, when “Control Panel” is chosen and then “Modem” tag is chosen in “Telephone and Modem Options”, a B-company product name is displayed on a display section 59 as follows:

Modem name: “Modem_B”

### EXAMPLE 2

In the case where the PC uses the Windows 2000® as the OS, if the device 50b, which is a B-company product, is connected to the PC, when “Control Panel” is chosen and then “Modem” tag is chosen in “Telephone and Modem Options”, “Diagnosis” tag is chosen in “Properties”, and then “Query Modem” is clicked, responses to AT commands are displayed on the display section 59 as follows:

| <Command> | <Response> |
|---|---|
| ATI1 | B_Corp Modem_B |
| ATI2 | Modem_B |
| ATI3 | B_Corp |

If the device 50a, which is an A-company product, is connected to the PC, “A_corp” and “Modem_A” are displayed in the response fields.

While the company name and the product name are displayed in this example, various applications can be contemplated, for example, different numbers of callings may be set for different OEM clients.

In addition, the device driver 56 has different operation modes for the function IDs 52a and 52b, that is, modes for the A company and B company, and provides a control operation corresponding to selected one of the operation modes.

Now, a fourth embodiment of the host machine according to the present invention will be described.

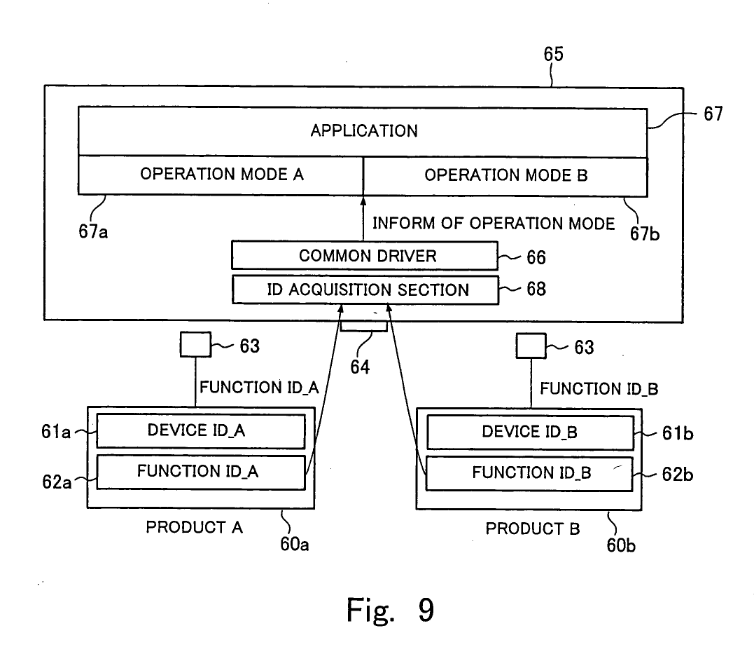

FIG. 9 is a schematic diagram showing the fourth embodiment of the host machine according to the present invention.

A host machine 65 in this embodiment corresponds to a third host machine according to the present invention.

As with the host machine of the second embodiment (see FIG. 7), the host machine of this embodiment uses a common device driver for plural devices, such as an A-company device and a B-company device. In addition, as with the devices of the first and second embodiments (see FIGS. 2 to 5), the devices connected to the host machine have essentially the same hardware and are produced on an OEM basis for plural clients, such as the A company and B company. The product name, initial value or the like of each device is changed for the OEM client by external setting thereof including the setting of the general I/O port.

As shown in FIG. 9, the PC 65 has a plug-and-play capability that allows the PC 65 to receive a device ID 61a or 61b for selecting a device driver 66 from a device 60a or 60b and select the device driver 66 when a USB connector 63 of the device 60a or 60b is plugged into a USB port 64.

Furthermore, the PC 65 has an ID acquisition section 68 that receives, from the connected device 60a or 60b, the device ID for selecting the device driver and a function ID 62a or 62b for selecting an operation mode of the device driver specified by the received device ID.

The device driver 66 is selected based on the device ID acquired by the ID acquisition section 68 and has a function of passing the function ID acquired by the ID acquisition section 68 to an application program 67 which uses the connected device under the control of the device driver 66.

The application program 67 has two selectable operation modes 67a and 67b, and the device driver 66 is informed of selected one of the operation modes.

Since such a PC 65 is used and different operation modes are set for the function IDs 62a and 62b, the device driver 66 can provide different control operations.

With such a configuration, a common device having a common essential component can be produced, a common device driver can be supplied to each OEM client, and plural devices, such as an A-company device and a B-company device, can operate on one PC in manners adapted for the respective OEM clients.

The PC 65 in this embodiment corresponds to the host machine according to the present invention.

Now, a fifth embodiment of the host machine according to the present invention will be described.

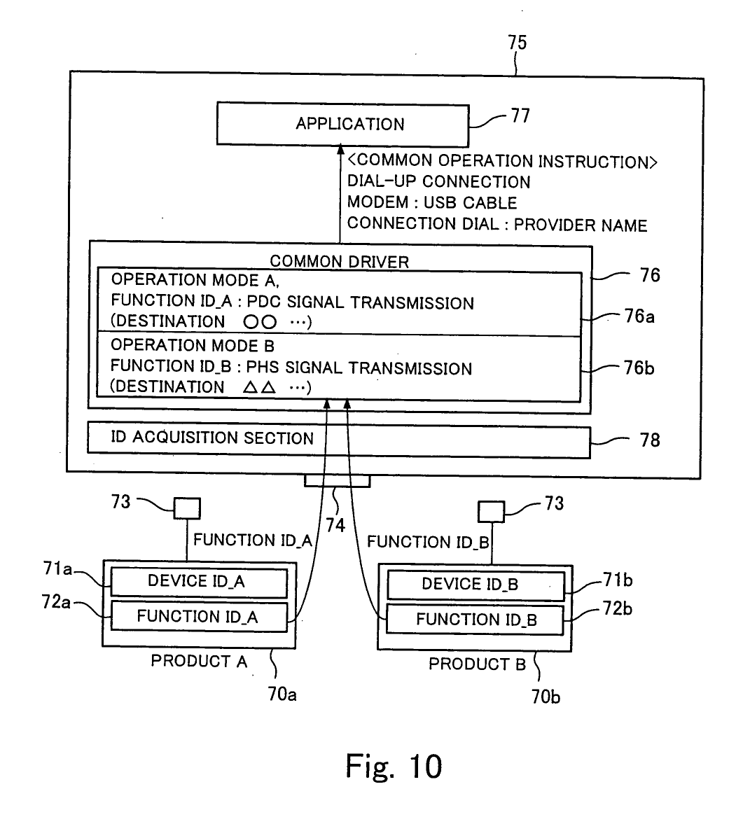

FIG. 10 is a schematic diagram showing the fifth embodiment of the host machine according to the present invention.

A host machine 75 of this embodiment corresponds to the second host machine according to the present invention and is a modification of the host machine 45 of the second embodiment.

As shown in FIG. 10, the PC 75 has a plug-and-play capability that allows the PC 75 to receive a device ID 71a or 71b for selecting a device driver 76 from a device 70a or 70b and select the device driver 76 when a USB connector 73 of the device 70a or 70b is plugged into a USB port 74.

Furthermore, the PC 75 has an ID acquisition section 78 that receives, from the connected device 70a or 70b, the device ID for selecting the device driver and a function ID 72a or 72b for selecting an operation mode of the device driver specified by the received device ID.

The device driver 76 is selected based on the device ID acquired by the ID acquisition section 78 and has two selectable operation modes 76a and 76b associated with the function IDs acquired by the ID acquisition section 78, and a control operation according to selected one of the operation modes is provided.

With such a configuration, for example, by previously setting the operation mode of the device 70a (product A) to the PDC (cellular phone) mode and the operation mode of the device 70b (product B) to the PHS mode on the device side and previously setting the NIFTY® access point information (dialing information) for the PDC mode and the NIFTY® access point information (dialing information) for the PHS mode in the device driver 76 on the PC 75 side using the TA commands, the device driver 76 can PDC-transmit signals to a predetermined destination ◯◯ in the operation mode A and PHS-transmit signals to a predetermined destination xx in the operation mode B as shown in FIG. 10.

In this case, the application program 77 issues a common operation instruction designating the connection type (dial up, for example), the modem type, the USB cable type, the connection dial, the provider name or the like to the device driver 76 regardless of the type of the device connected to the PC, and switching to the operation mode corresponding to the connected device is conducted in the device driver 76.

Thus, unlike conventional systems, for example, when a user who has both a USB cable for PDC (cellular phone) data communication and a USB cable for PHS data communication and wants to change the provider for a reason concerned with the mail software, browser or the like, the user can continue to use the PC only by changing the USB cable in use to a desired one, without modifying the settings of the application.

The PC 75 in this embodiment corresponds to the host machine according to the present invention.

Now, an operation of the host machine of the fifth embodiment described above will be described.

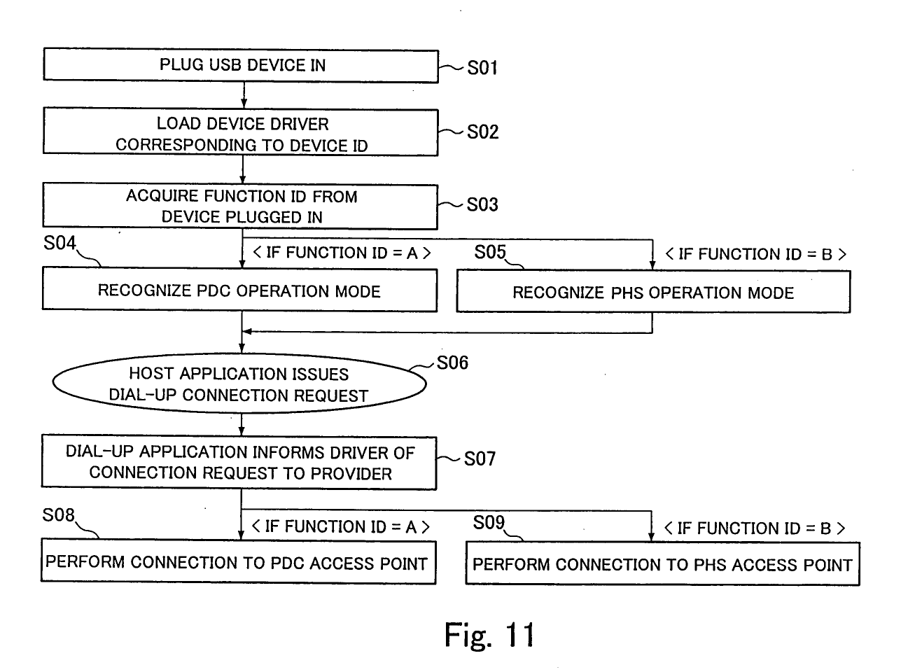

FIG. 11 is a flowchart illustrating an operation of the host machine of the fifth embodiment.

As shown in FIG. 11, when the USB connector 73 of the USB device 70a or 70b is plugged into the USB port 74 of the host machine 75 (see FIG. 10) (step S01), the host machine 75 reads the device ID 71a or 71a retained in the USB device and loads the device driver 76 (common driver) available for the device ID (step S02).

Then, the host machine 75 acquires the function ID from the USB device plugged into the host machine (step S03). If the function ID acquired is the function ID 72a, that is, the function ID for the product A, the operation mode A, that is, the PDC (cellular phone) mode is recognized (step S04). On the other hand, if the function ID acquired is the function ID 72b, that is, the function ID for the product B, the operation mode B, that is, the PHS mode is recognized (step S05).

Then, a host application program issues a request for dial-up connection (step S06). In setting the destination of the connection by the dial-up application program, there is no need to discriminate between the PDC and PHS modes. That is, there is no need to change the connection type set in the mail application or browser between PDC transmission and PHS transmission.

Then, a dial-up application program informs the device driver (common driver) 76 of the connection request to the provider (step S07).

At this point in time, if the function ID is the function ID 72a, that is, the function ID for the product A, connection to an access point for PDC is performed (step S08), and if the function ID is the function ID 72b, that is, the function ID for the product B, connection to an access point for PHS is performed (step S09).

1. A device that has a plug-and-play capability that allows the device to pass a device ID for selecting a device driver that controls the device to a host machine when connected to the host machine and operates under the control of the device driver in the host machine to which the device is connected, comprising:
an ID retaining section that retains a plurality of device IDs in a selectable manner.

2. The device according to claim 1, further comprising: an ID selecting section that fixedly selects, from among the plurality of device IDs retained in the ID retaining section, a device ID to be passed to the host machine when the device is connected to the host machine.

3. A device that has a plug-and-play capability that allows the device to pass a device ID for selecting a device driver that controls the device to a host machine when connected to the host machine and operates under the control of the device driver in the host machine to which the device is connected, comprising:
an ID retaining section that retains the device ID and retains, in a selectable manner, a plurality of function IDs representing operation modes to be passed to the host machine when the device is connected to the host machine.

4. The device according to claim 3, further comprising: an ID selecting section that fixedly selects, from among the plurality of function IDs retained in the ID retaining section, a function ID to be passed to the host machine along with the device ID when the device is connected to the host machine.

5. A host machine that has a plug-and-play capability that allows the host machine to receive a device ID for selecting a device driver that controls a device and select the device driver when a device is connected thereto and controls the connected device using the device driver corresponding to the device ID received from the device, comprising:
a plurality of information files that describe file names of the device driver and are associated with device IDs; and
a device driver setting section that selects, based on a device ID for selecting a device driver received from the device connected thereto, an information file corresponding to the device ID from among the plurality of information files and sets a device driver corresponding to the file name described in the selected information file as the device driver for the device connected thereto,
wherein the plurality of information files are associated with different device IDs and include a plurality of information files describing the same file name.

6. The host machine according to claim 5, wherein the information files each describe a file name of the device driver and a device name,
the plurality of information files provided in the host machine are associated with different device IDs and include a plurality of information files describing the same file name and different names, and
the host machine further comprises a display section that displays the name described in the information file selected based on the device ID.

7. A host machine that has a plug-and-play capability that allows the host machine to receive a device ID for selecting a device driver that controls a device and select the device driver when a device is connected thereto and controls the connected device using the device driver corresponding to the device ID received from the device, comprising:
an ID acquisition section that receives the device ID for selecting a device driver from the connected device and receives a function ID for selecting an operation mode of the device driver selected based on the device ID; and
the device driver which is selected based on the device ID acquired by the ID acquisition section and whose operation mode is selected based on the function ID acquired by the ID acquisition section.

8. A host machine that has a plug-and-play capability that allows the host machine to receive a device ID for selecting a device driver that controls a device and select the device driver when a device is connected thereto and controls the connected device using the device driver corresponding to the device ID received from the device, comprising:
an ID acquisition section that receives the device ID for selecting a device driver from the connected device and receives a function ID for selecting an operation mode of the device driver selected based on the device ID; and
the device driver which is selected based on the device ID acquired by the ID acquisition section and passes the function ID acquired by the ID acquisition section to an application program that uses the connected device under the control of the device driver.
